(19) United States
(12) Patent Application Publication
(10) Pub. No.: US 2015/0148231 A1
(43) Pub. Date: May 28, 2015

(54) MIXTURES FOR REDUCING NITROUS OXIDE AND/OR AMMONIA EMISSION FROM SOILS

(71) Applicant: BASF SE, Ludwigshafen (DE)

(72) Inventors: Barbara Nave, Ruppertsberg (DE); Lutz Brahm, Worms (DE); Daniella Lohe, Limburgerhof (DE); Alexander Wissemeier, Speyer (DE); Wolfram Zerulla, Maikammer (DE); Achim Reddig, Lambrecht (DE); Markus Schmid, Deidesheim (DE); Gregor Pasda, Neustadt (DE)

(21) Appl. No.: 14/406,398

(22) PCT Filed: Feb. 15, 2013
(86) PCT No.: PCT/IB2013/051231

§ 371 Date: Dec. 8, 2014

Related U.S. Application Data
(60) Provisional application No. 61/599,442, filed on Feb. 16, 2012.

(51) Int. Cl. C05G 3/08; C05G 3/02; A01N 47/24

(52) U.S. Cl. CPC C05G 3/08; A01N 47/24; C05G 3/02
USPC 504/101; 504/282

(57) ABSTRACT

The present invention relates to an agrochemical mixture for reducing nitrous oxide and/or ammonia emission from soils, comprising:

1) a composition (component A) comprising N-n-butylthiophosphoric triamide (NBTPT) and/or N-n-propylthiophosphoric triamide (NPTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[(1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide

in synergistically effective amounts.

In addition, the present invention relates to the use of a mixture as defined above for synergistically reducing nitrous oxide emission from soils.

Moreover, the present invention relates to the use of a mixture as defined above for synergistically reducing ammonia emission from soils.

### The present invention relates to an agrochemical mixture for reducing nitrous oxide and/or ammonia emission from soils, comprising:

1) a composition (component A) comprising N-n-butylthiophosphoric triamide (NBTPT) and/or N-n-propylthiophosphoric triamide (NPTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide

in synergistically effective amounts.

Furthermore, the present invention relates to an agrochemical mixture for reducing nitrous oxide and/or ammonia emission from soils, comprising

1) a composition (component A) comprising N-n-butylthiophosphoric triamide (NBTPT) and/or N-n-propylthiophosphoric triamide (NPTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide

in synergistically effective amounts. 3) at least one fertilizer comprising urea (component C)

In addition, the present invention relates to the use of a mixture as defined above for synergistically reducing nitrous oxide emission from soils.

Moreover, the present invention relates to the use of a mixture as defined above for synergistically reducing ammonia emission from soils.

Nitrogen is an essential element for plant growth and reproduction. About 25% of the plant-available nitrogen in soils (ammonium and nitrate) originates from decomposition processes (mineralization) of organic nitrogen compounds such as humus, plant and animal residues and organic fertilizers. Approximately 5% derive from rainfall. On a global basis, the biggest part (70%), however, is supplied to the plant by inorganic nitrogen fertilizers. Without the use of nitrogenous fertilizers, the earth would not be able to support its current population.

A significant part of the nitrogen applied globally for fertilization purposes is employed in the form of urea (CO(NH₂)₂) or fertilizer comprising urea. One of the reasons is that urea has the highest nitrogen content of all solid nitrogenous fertilizers in common use. It is generally found in granular or prill form which has the advantage that urea can be easily stored, transported and applied in agricultural systems. Since urea is highly water soluble, it can be used in spray applications or even through irrigation systems. Due to the fact that urea is not an oxidizer at standard temperature and pressure, it is also safe to handle and store. Even though urea as such is a form of nitrogen which can be taken up by the plants, its nitrogen is usually absorbed by plants after it has been broken down. This usually happens as soon as urea is applied to the soil and as long as a certain degree of soil moisture is present. Under suitable conditions, urea is hydrolyzed to carbamic acid by an enzyme called urease. Since carbamic acid is unstable, it decomposes to ammonia (NH₃) and carbon dioxide (CO₂). If the ammonia does not react with soil water to form ammonium (NH₄⁺, which is a form of nitrogen that can be readily taken up by the plants, the gaseous ammonia might be released to the atmosphere. This process is called “ammonia volatilization” and is responsible for significant losses of nitrogen. As a result, the nitrogen is no longer available to the plant, thus reducing the efficacy of fertilization. In addition, urea seems to be responsible for a significant emission of nitrous oxide (N₂O) (Khalil et al. (2002): Nitrous oxide production from an ultisol treated with different nitrogen sources and moisture regimes. Biol. Fertil. Soils 36: 59-65). This is especially crucial because nitrous oxide has a large potential for global warming, ozone-layer depletion and climate change.

Furthermore, ammonia is known to be jointly responsible for eutrophication of surface waters, soil acidification and changes in ecosystems. With respect to urban living, it may also contribute to smog and decreased visibility in cities and pristine areas. Depending on the concentration as well as the period of exposure, ammonia may have adverse effects on human health resulting in diseases such as bronchitis, asthma, coughing, and farmers lung.

Ammonia emissions are continuing to increase rapidly in various parts of the world, so that the above defined concerns must be expected to grow in future. In Europe, strong efforts are presently being made to decrease ammonia emissions. However, it turned out that reducing ammonia emissions is a challenging task, with only modest success to date.

There are various possibilities or factors that can reduce ammonia losses depending on the soil type and its water-transmission characteristics. Among others, urea may be mixed with soils or placed deeply in the soil. Immediate rainfall or rapid drying of the surface soil after application of urea may also have an impact on ammonia losses (Bouwmeester et al. (1985): Effect of environmental factors on ammonia volatilisation from a urea-fertilized soil. Soil Sci. Soc. Am. J. 49: 376-381; Khalil et al. (2009): Effects of urease and nitrification inhibitors added to urea on nitrous oxide emissions from a loess soil. J. Plant Nutr. Soil Sci. 172: 651-660).

It is known that production of ammonia and as a result the nitrogen losses can be reduced if the fertilizer comprising urea is applied together with a urease inhibitor which is able to reduce or inhibit the enzymatic cleavage of urea (Kiss and Simih\check{a}ian (2002): Improving

Efficiency of Urea Fertilizers by Inhibition of Soil Urease Activity. ISBN 1-4020-0493-1, Kluwer Academic Publishers, Dordrecht, The Netherlands). These inhibitors are able to prevent the urease enzyme from breaking down the urea or at least to decrease the speed of the hydrolysis of urea in the soil. This in turn increases the probability that urea will be absorbed to the soil rather than volatilized into the atmosphere which results in an improvement of the fertilizing effect (Gans et al. (2006): Nitrogen balance in the system plant-soil after urea fertilization combined with urease inhibitors. Plant Soil Environ. 52: 36-38). The most potent known urease inhibitors include N-alkylthiophosphoric triamides and N-alkylphosphoric triamides, which are described for example in EP 0119487.

Besides urease inhibitors, the use of urea supergranule may be an effective option with regard to increasing agronomic efficiency and reducing gaseous N losses, particularly NH₃ (Khalil et al. (2006): N₂O, NH₃ and NOₓ emissions as a function of urea granule size and soil type under aerobic conditions. Water, Air, Soil Pollut. 175: 127-148.).

In general, soil nitrogen exists in three basic forms: organic nitrogen compounds, ammonium (NH₄⁺) ions and nitrate (NO₃⁻) ions. While (NH₄⁺) ions and nitrate (NO₃⁻) ions are highly plant-available nitrogen forms, most organic matter is not directly available to plants. However, soil microorganisms are able to convert organic nitrogen to ammonium (NH₄⁺) which is subsequently oxidized to nitrate (NO₃⁻)in processes known “mineralization” and “nitrification”. Nitrate is very important in agriculture, because (as pointed out above) it is one form of nitrogen which is preferably taken up by the plants due to its high plant-availability. However, nitrate is also highly mobile in the soil. As a consequence, it may be readily lost from soils leaching to groundwater. In addition, nitrogen is lost by a process called “denitrification” which is the microbiological conversion of nitrate and nitrite (NO₂⁻) ) to gaseous forms of nitrogen such as nitrous oxide (N₂O) and molecular nitrogen (N₂⁻). As a result, approximately 50% of the applied nitrogen is lost during the year following fertilizer addition due to the various forms of losses (Nelson and Huber (2001): Nitrification inhibitors for corn production. National Corn Handbook, Iowa State University).

Nitrification and denitrification are the two main processes by which nitrous oxide is produced in soil environments. It is expected that the yearly application of nitrogen fertilizers and pesticides will more than double over the next 50 years. In addition, the agricultural cropland is expected to increase by 5.5×10⁸ ha hectares by the year 2050 (Tilman et al. (2001): Forecasting agriculturally driven global environmental change. Science. 292: 281-284). As a consequence, agricultural soils will likely have an ever-increasing influence on the global atmospheric budgets of carbon dioxide, nitrous oxide and methane. With respect to agricultural production systems, it could be shown that fertilization and tillage more than double N₂O emissions from soils.

There is also concern that the intensive use of fertilizer and the application of livestock wastes could lead to increased nitrogen levels in groundwater and surface waters, and that this in turn could lead to increased eutrophication of lakes and streams.

Besides the potential impact on global warming, the production of N₂O reduces the amount of nitrogen available to the plants.

In addition, nitrogen fertilization and livestock wastes may increase the production of nitrous oxide, significantly contributing to the stratospheric ozone destruction and global warming. Besides nitrous oxide, carbon dioxide (CO₂) and methane (CH₄) are important gases produced by native and agricultural soils. Depending on various parameters such as weather and soil type, increased fertilization and tillage can additionally increase nitrous oxide emissions.

As a consequence, one of the biggest challenges to the world community in the coming years will be the reduction of gases responsible for the greenhouse effect in the atmosphere or at least the stabilization of greenhouse gas concentrations in the atmosphere at a level that would prevent dangerous anthropogenic interference with the climate system. This concern is expressed in the Kyoto Protocol in which the ratifying countries commit to reduce their emissions of greenhouse gases or engage in emissions trading if they maintain or increase emissions of these gases.

The best known greenhouse gas is carbon dioxide. However, as pointed out above, nitrous oxide must be regarded as another cause of great concern. Throughout the 20th century and continuing into the 21st century, nitrous oxide has increased by 50 parts per billion in the atmosphere and is rising further by 0.25% each year. Although nitrous oxide only accounts for around 9% of the total greenhouse gas emissions, one has to keep in mind that it has a 300-fold greater global warming potential than carbon dioxide over the next 100 years and an atmospheric lifetime of approximately 150 years.

The above listed trends may result in increased levels of nitrogen in natural waters, crop residue, and municipal and agricultural wastes, creating national and international concerns about the environment and public health.

Consequently, a unilateral and independent target of the European Union to reduce greenhouse-gas (GHG) emissions (including N₂O and NH₃) by 20% to 1990 levels by 2020 has been adopted in compliance with the Kyoto and Bali protocols (Commission of the European Communities (2008): Proposal for a decision of the European parliament and of the Council. 2008/0014 (COD), Brussels, pp. 1-26.).

It was therefore an object of the present invention to solve the problems as outlined above which are correlated to the intensive application of urea or fertilizer comprising urea in agricultural, in particular to reduce nitrous oxide and/or ammonia emission from soils.

We have found that these objects are in part or in whole achieved by using the agrochemical mixtures as defined in the outset. Surprisingly, it has been found that the application of an agrochemical mixture comprising a composition comprising N-n-butylthiophosphoric triamide (NBTPT) and/or N-n-propylthiophosphoric triamide (NPTPT) as component (A) and at least one strobilurin as component (B) in synergistically effective amounts allows a greater reduction of ammonia and/or nitrous oxide emission from soils than when the same amount of each component is applied on its own.

The application of the agrochemical mixtures according to the method of the invention provides significant ecological and economic advantages. From an ecological stand point, the cutback of ammonia and/or N₂O emissions significantly reduces the impact of modern agriculture on the environment and its atmosphere as well as on global warming. In addition, losses of nitrogen to the groundwater, risk of eutrophication of lakes and streams are also minimized due to an optimized use of soil nitrogen.

Dharnaraj P. S. (in Lal and Lal (Editors. Effects of pesticides on nitrification and denitrification (1988). Pesticides and Nitrogen Cycle) describes the effect of various pesticides on nitrification and denitrification.

Mosier et al. (Nitrous oxide emission from agricultural fields; Assessment, measurement and mitigation (1996). Plant and Soil 131: 95-108) summarized the effects of nitrification inhibitors on N₂O emissions from fertilized soils. A number of studies indicated that nitrification inhibitors did limit N₂O emission from soils fertilized with urea- or ammonium-based fertilizers.

Kinney et al. (Effects of fungicides on trace gas fluxes (2004). Journal of Geophysical Research 109: 1-15) have hypothesized that the variations in gases flux from agricultural soils may also be affected by the quantity and type of agricultural chemicals (pesticides) used. They carried out field experiments and determined the effect to two commonly used multi-site fungicides, mancozeb and chlorothalonil, on trace gas exchange. Kinney et al. (Laboratory investigations into the effects of the pesticides mancozeb, chlorothalonil, and prosulfuron on nitrous oxide and nitric oxide production in fertilized soil (2005). Soil Biology & Biochemistry 37: 837-850) additionally investigated the effects of mancozeb, chlorthalonil and the herbicide prosulfuron on N₂O production by nitrifying and denitrifying bacteria in fertilized soil.

Somda et al. (Influence of biocides on tomato nitrogen uptake and soil nitrification and denitirification (1991). Journal of Plant Nutrition 14 (11): 1187-99) investigated the impact of benlate, captan, and lime-sulfur fungicides compared to nitrification inhibitors on nitrification.

Jastrzebska and Kucharski (Dehydrogenases, urease and phosphatases activities of soil contaminated with fungicides (2007). Plant Soil Environ. 53: 51-57) discloses that a contamination of the soil with fungicides (cyprodinil or a mixture comprising dimoxystrobin and epoxiconazole) significantly inhibited the activity of urease at concentrations 100 times the field rate and subsequently resulted in a substantial negative effect on spring barley yield.

Khalil et al. (Effects of urease and nitrification inhibitors added to urea on nitrous oxide emissions from a loess soil (2009). J. Plant Nutr. Soil Sci. 172: 651-660) describes the effect of urea granule (2-3 mm) added with a new urease inhibitor, a nitrification inhibitor, and with a combined urease inhibitor and nitrification inhibitor on N₂O emissions.

DE 102005053541 discloses methods for obtaining (thio)phosphoric triamides.

WO 98/05607 is directed to the use of inorganic or organic polyacids for the treatment of inorganic fertilizers, in particular the use of the polyacids as a mixture with at least one nitrification inhibitor for the treatment of inorganic fertilizers.

WO 07/054392 relates to a process for the improved removal of acids from polar reaction mixtures by means of unpolar amines. Furthermore, the invention relates to a process for the preparation of thiophosphoric triamides, to the thiophosphoric triamides obtainable by this process, and to the use of these thiophosphoric triamides as additive to urea-comprising mineral and/or organic-mineral fertilizers.

WO 07/093528 relates to preparations with improved urease-inhibitory effect which comprise at least two different (thio)phosphoric triamides and to urea-comprising fertilizers which comprise these preparations and to methods for producing these preparations.

WO 08/059053 relates to a method for increasing the carbon dioxide sequestration from the atmosphere by treating a plant, a part of the plant, the locus where the plant is growing or is intended to grow and/or the plant propagules with certain active ingredients. The invention also relates to the use of the compounds for increasing the dry biomass of a plant.

WO 09/121786 relates to a method for reducing nitrous oxide emission from soils comprising treating a plant growing on the respective soil and/or the locus where the plant is growing or is intended to grow and/or the seeds from which the plant grows with at least one fungicide (such as strobilurins) and at least one ammonium- or urea-containing fertilizer wherein the application of the fungicide and the fertilizer is carried out with a time lag of at least 1 day.

WO 09/121786 is directed to a process for the preparation of triamides from ammonia and amido-dichlorides.

Urease inhibitors are able to inhibit the urease enzyme from breaking down the urea. As a result, the probability that urea will be absorbed into the soil after a rain event, rather than being volatilized into the atmosphere, is greatly enhanced.

Various chemicals have been evaluated as soil urease inhibitors (Kiss, S. and Simihaian, M. (2002) Improving Efficiency of Urea Fertilizers by Inhibition of Soil Urease Activity. Kluwer

Academic Publishers) and they were classified according to their structures and their mode of action (Watson, C. J. (2000). Urease activity and inhibition—principles and practice. Proceedings No. 454. Publ., The International Fertilizer Society, York, UK. 40pp.). Today it is assumed that urease inhibitors can interact with either the active site of the enzyme itself or with a functional group elsewhere in the molecule. Due to the change of the conformation of the active sites urea hydrolysis is reduced. Urease inhibitors may be divided into four main groups: (i) reagents which interact with the sulphydryl groups (sulphydryl reagents), (ii) hydroxamates, (iii) agricultural crop protection chemicals, and (iv) structural analogues of urea and related compounds (Watson, C. J. (2005) Urease inhibitors. IFA International Workshop on Enhanced-Efficiency Fertilizers Frankfurt, Germany). Only a few, however, meet the requirements of being effective at low concentrations, non-toxic, stable, inexpensive and compatible with urea.

Thiophosphoric triamides, specifically N-n-butylthiophosphoric triamide (NBTPT) and N-n-propylthiophosphoric triamide (NPTPT), are effective urease inhibitors which are employed in urea-based fertilizer compositions. They belong to the group of thiophosphorotriamides which are structural analogues of urea. They inhibit the soil urease activity by blocking the active site of the enzyme.

N-n-butylthiophosphoric triamide (NBTPT) and N-n-propylthiophosphoric triamide (NPTPT) as well as their urease inhibiting action is generally known. Methods for producing them are described in WO 07/093528 (US 2010/0218575). Further information can be found for example in DE 102005053541, WO 2007/054392 and WO 2009/121786.

Strobilurins must be regarded as one class of active compounds since they display key similarities in their chemical background as well as a high target specificity based upon an identical mode of action. Strobilurins bind to a very specific site in the mitochondria which is called the quinol oxidation (Q_{O}) site (or ubiquinol site) of cytochrome b. As a result, they are capable of stopping the electron transfer between cytochrome b and cytochrome c, which leads to reduced nicotinoamide adenine dinucleotide (NADH) oxidation and adenosin triphosphate (ATP) synthesis. As the central consequence, the energy production of the treated organism (e.g. a fungus) will come to an end and the organism will eventually die. Due to this special mode of action, strobilurins are highly target specific. This mode of action is unique and applies to all members of the strobilurin class. Besides its fungicidal properties, pyraclostrobin is able to increase the health of a plant. Among others, it could be proven that it increases the resistance of plants against biotic stress such as bacteria or fungi as well as abiotic stress such as cold stress.

It is already known from the literature that strobilurins, are capable of bringing about increased yields in crop plants in addition to their fungicidal action (Koehle H. et al. (1997) in Gesunde Pflanzen 49: 267-271; Glaab J. et al. (1999): Increased nitrate reductase activity in leaf tissue after application of the fungicide Kresoxim-methyl. Planta 207: 442-448)).

Strobilurins as well as their pesticidal action and methods for producing them are generally known. For instance, the commercially available compounds can be found in “The Pesticide Manual, 15th Edition, British Crop Protection Council (2009)” among other publications.

In one embodiment according to the invention, the agrochemical mixture for reducing nitrous oxide emission from soils comprises:

1) a composition (component A) comprising N-n-butylthiophosphoric triamide (NBTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide

in synergistically effective amounts.

In another embodiment according to the invention, the agrochemical mixture for reducing nitrous oxide emission from soils comprises:

1) a composition (component A) comprising N-n-propylthiophosphoric triamide (NPTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide

in synergistically effective amounts.

In a preferred embodiment according to the invention, the agrochemical mixture for reducing nitrous oxide emission from soils comprises:

1) a composition (component A) comprising N-n-butylthiophosphoric triamide (NBTPT) and N-n-propylthiophosphoric triamide (NPTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide

in synergistically effective amounts.

In one embodiment according to the invention, the agrochemical mixture for reducing ammonia emission from soils comprises:

1) a composition (component A) comprising N-n-butylthiophosphoric triamide (NBTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide,

in synergistically effective amounts.

In another embodiment according to the invention, the agrochemical mixture for reducing ammonia emission from soils comprises:

1) a composition (component A) comprising N-n-propylthiophosphoric triamide (NPTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide

in synergistically effective amounts.

In a preferred embodiment according to the invention, the agrochemical mixture for reducing ammonia emission from soils comprises:

1) a composition (component A) comprising N-n-butylthiophosphoric triamide (NBTPT) and N-n-propylthiophosphoric triamide (NPTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide

in synergistically effective amounts.

In one embodiment according to the invention, the agrochemical mixture comprises a strobilurin (component B) selected from the group consisting of pyraclostrobin, orysastrobin, azoxystrobin, dimoxystrobin, enestroburin, fluoxastrobin, kresoxim-methyl, metominostrobin, picoxystrobin, and trifloxystrobin.

In a preferred embodiment according to the invention, the agrochemical mixture comprises a strobilurin (component B) selected from the group consisting of azoxystrobin, pyraclostrobin and trifloxystrobin.

In an especially preferred embodiment according to the invention, the strobilurin (component B) is pyraclostrobin.

In an especially preferred embodiment according to the invention, the agrochemical mixture comprises a composition comprising N-n-butylthiophosphoric triamide (NBTPT) as component (A) and pyraclostrobin as component (B) in synergistically effective amounts.

In an especially preferred embodiment according to the invention, the agrochemical mixture comprises a composition comprising N-n-propylthiophosphoric triamide (NPTPT) as component (A) and pyraclostrobin as component (B) in synergistically effective amounts.

In an especially preferred embodiment according to the invention, the agrochemical mixture comprises a composition comprising N-n-butylthiophosphoric triamide (NBTPT) and N-n-propylthiophosphoric triamide (NPTPT) as component (A) and pyraclostrobin as component (B) in synergistically effective amounts.

In one embodiment according to the invention, the agrochemical mixture additionally comprises at least one fertilizer comprising urea (component C).

In one embodiment according to the invention, the fertilizer (component C) comprises urea in a form selected from the group consisting of urea, urea ammonium nitrate (UAN), isobutylidene diurea (IBDU), crotonylidene diurea (CDU) and urea formaldehyde (UF).

Consequently, in one embodiment according to the invention, the agrochemical mixture for reducing nitrous oxide and/or ammonia emission from soils, comprises:

1) a composition (component A) comprising N-n-butylthiophosphoric triamide (NBTPT) and/or N-n-propylthiophosphoric triamide (NPTPT); and

2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide

in synergistically effective amounts; and 3) at least one fertilizer comprising urea (component C).

In one embodiment according to the invention, the agrochemical mixture for reducing nitrous oxide emission from soils, comprises: 1) a composition (component A) comprising N-n-butylthiophosphoric triamide (NBTPT); and 2) at least one strobilurin (component B) as defined above, in synergistically effective amounts; and 3) at least one fertilizer comprising urea (component C).

In another embodiment according to the invention, the agrochemical mixture for reducing nitrous oxide emission from soils, comprises: 1) a composition (component A) comprising N-n-propylthiophosphoric triamide (NPTPT); and 2) at least one strobilurin (component B) as defined above, in synergistically effective amounts; and 3) at least one fertilizer comprising urea (component C).

In a preferred embodiment according to the invention, the agrochemical mixture for reducing nitrous oxide emission from soils, comprises:

1) a composition (component A) comprising N-n-butylthiophosphoric triamide (NBTPT) and N-n-propylthiophosphoric triamide (NPTPT); and 2) at least one strobilurin (component B) as defined above, in synergistically effective amounts; and 3) at least one fertilizer comprising urea (component C).

In one embodiment according to the invention, the agrochemical mixture for reducing ammonia emission from soils, comprises: 1) a composition (component A) comprising N-n-butylthiophosphoric triamide (NBTPT); and 2) at least one strobilurin (component B) as defined above, in synergistically effective amounts; and 3) at least one fertilizer comprising urea (component C).

In another embodiment according to the invention, the agrochemical mixture for reducing ammonia emission from soils, comprises:

1) a composition (component A) comprising N-n-propylthiophosphoric triamide (NPTPT); and 2) at least one strobilurin (component B) as defined above, in synergistically effective amounts; and 3) at least one fertilizer comprising urea (component C).

In a preferred embodiment according to the invention, the agrochemical mixture for reducing ammonia emission from soils, comprises: 1) a composition (component A) comprising N-n-butylthiophosphoric triamide (NBTPT) and N-n-propylthiophosphoric triamide (NPTPT); and 2) at least one strobilurin (component B) as defined above, in synergistically effective amounts; and 3) at least one fertilizer comprising urea (component C).

In one embodiment according to the invention, the nitrous oxide and/or ammonia emission from soils is reduced by applying the agrochemical mixture together with at least one nitrification inhibitor (component D) selected from the group consisting of 2-(3,4-dimethyl-pyrazol-1-yl)-succinic acid, 3,4-dimethylpyrazole (DMP), 3,4-dimethylpyrazolephosphate (DMPP), dicyandiamide (DCD), 1H-1,2,4-triazole, 3-methylpyrazole (3-MP), 2-chloro-6-(trichloromethyl)-pyridine, 5-ethoxy-3-trichloromethyl-1,2,4-thiadiazol, 2-amino-4-chloro-6-methyl-pyrimidine, 2-mercapto-benzothiazole, 2-sulfanilamidothiazole, thiourea, sodium azide, potassium azide, 1-hydroxypyrazole, 2-methylpyrazole-1-carboxamide, 4-amino-1,2,4-triazole, 3-mercapto-1,2,4-triazole, 2,4-diamino-6-trichloromethyl-5-triazine, carbon bisulfide, ammonium thiosulfate, sodium trithiocarbonate, 2,3-dihydro-2,2-dimethyl-7-benzofuranol methyl carbamate and N-(2,6-dimethylphenyl)-N-(methoxyacetyl)-alanine methyl ester.

In a preferred embodiment of the method according to the invention, the nitrous oxide and/or ammonia emission from soils is reduced by applying the agrochemical mixture together with at least one nitrification inhibitor (component D) selected from the group consisting of 2-(3,4-dimethyl-pyrazol-1-yl)-succinic acid, 3,4-dimethylpyrazole (DMP), 3,4-dimethylpyrazole-phosphate (DMPP), dicyandiamide (DCD), 1H-1,2,4-triazole, 3-methylpyrazole (3-MP), 2-chloro-6-(trichloromethyl)-pyridine and 5-ethoxy-3-trichloromethyl-1,2,4-thiadiazol.

In one embodiment according to the invention, the agrochemical mixture comprising a composition (component A) comprising N-n-butylthiophosphoric triamide (NBTPT) and/or N-n-propylthiophosphoric triamide (NPTPT) and at least one strobilurin (component B) is applied together with at least one fertilizer comprising urea (component C).

In one embodiment according to the invention, the agrochemical mixture comprising a composition (component A) comprising N-n-butylthiophosphoric triamide (NBTPT) and/or N-n-propylthiophosphoric triamide (NPTPT) and at least one strobilurin (component B) is applied together with at least one nitrification inhibitor (component D).

In one embodiment according to the invention, the agrochemical mixture comprising a composition (component A) comprising N-n-butylthiophosphoric triamide (NBTPT) and/or N-n-propylthiophosphoric triamide (NPTPT) and at least one strobilurin (component B) is applied together at least one fertilizer comprising urea (component C) and with at least one nitrification inhibitor (component D).

The remarks as to embodiments of the component (A) and (B) and mixtures comprising at least one component (A) and at least one component (B) and mixtures additionally comprising at least one component (C) and/or at least one component (D), to their preferred use and methods of using them are to be understood either each on their own or preferably in combination with each other.

In the terms of the present invention, N-n-butylthiophosphoric triamide (NBTPT), N-n-propylthiophosphoric triamide (NPTPT) as well as strobilurins, fertilizer comprising urea and nitrification inhibitor as defined above are regarded as “active compounds” or “compounds”.

In the terms of the present invention “agrochemical mixture” is not restricted to a physical mixture comprising at least two active compounds, but refers to any preparation form of at least two active compounds, the use of which is time and locus-related.

The agrochemical mixture may be co-formulated or formulated separately. If the agrochemical mixture is formulated separately, the active compounds are applied in a temporal relationship, i.e. simultaneously or subsequently, whereas the subsequent application is carried out within a time interval which allows the combined action of the active compounds.

The subsequent application is carried out with a time interval which allows a combined action of the applied components (active compounds). Preferably, the time interval for a subsequent application of a first component and a second component ranges from a few seconds up to 6 months, preferably, from a few seconds up to 3 months, more preferably from a few seconds up to 3 weeks, even more preferably from a few seconds up to 3 days and in particular from 1 second up to 24 hours; provided that the time interval allows a combined action of the active compounds.

In one embodiment of the invention, components (A), (B), (C) and (D) are formulated separately but applied simultaneously or subsequently, whereas the subsequent application is carried out within a time interval which allows a combined action of the individual components.

In one embodiment of the invention, the components of the agrochemical mixture are co-formulated and applied simultaneously or subsequently.

In one embodiment of the invention, components (A) and (C) are co-formulated and applied simultaneously.

In one embodiment of the invention, the components of the agrochemical mixture are formulated separately and applied simultaneously or subsequently.

Furthermore, the individual active compounds (components) of the agrochemical mixture according to the invention such as parts of a kit may be mixed by the user himself in a spray tank and further auxiliaries may be added, if appropriate (tank mix). This applies also in case ternary or quaternary mixtures are used according to the invention.

With respect to their intended use in the methods of the present invention, the following mixtures listed in table 1, comprising NBTPT and/or NPTPT as component (A) and a strobilurin as component (B), are an especially preferred embodiment of the present invention.

TABLE 1

| | (A) | (B) |
|---|---|---|
| M-1 | NBTPT | pyraclostrobin |
| M-2 | NBTPT | orysastrobin |
| M-3 | NBTPT | azoxystrobin |
| M-4 | NBTPT | dimoxystrobin |
| M-5 | NBTPT | enestroburin |
| M-6 | NBTPT | fluoxastrobin |
| M-7 | NBTPT | kresoxim-methyl |
| M-8 | NBTPT | metominostrobin |
| M-9 | NBTPT | picoxystrobin |
| M-10 | NBTPT | trifloxystrobin |
| M-11 | NBTPT | pyrametostrobin |
| M-12 | NBTPT | pyraoxystrobin |
| M-13 | NBTPT | coumoxystrobin |
| M-14 | NBTPT | coumethoxystrobin |
| M-15 | NBTPT | fenaminostrobin |
| M-16 | NBTPT | flufenoxystrobin |
| M-17 | NPTPT | pyraclostrobin |
| M-18 | NPTPT | orysastrobin |
| M-19 | NPTPT | azoxystrobin |
| M-20 | NPTPT | dimoxystrobin |
| M-21 | NPTPT | enestroburin |
| M-22 | NPTPT | fluoxastrobin |
| M-23 | NPTPT | kresoxim-methyl |
| M-24 | NPTPT | metominostrobin |
| M-25 | NPTPT | picoxystrobin |
| M-26 | NPTPT | trifloxystrobin |
| M-27 | NPTPT | pyrametostrobin |
| M-28 | NPTPT | pyraoxystrobin |
| M-29 | NPTPT | coumoxystrobin |
| M-30 | NPTPT | coumethoxystrobin |
| M-31 | NPTPT | fenaminostrobin |
| M-32 | NPTPT | flufenoxystrobin |
| M-33 | NBTPT + | pyraclostrobin |
| | NPTPT | |
| M-34 | NBTPT + | orysastrobin |
| | NPTPT | |
| M-35 | NBTPT + | azoxystrobin |
| | NPTPT | |
| M-36 | NBTPT + | dimoxystrobin |
| | NPTPT | |
| M-37 | NBTPT + | enestroburin |
| | NPTPT | |
| M-38 | NBTPT + | fluoxastrobin |
| | NPTPT | |
| M-39 | NBTPT + | kresoxim-methyl |
| | NPTPT | |
| M-40 | NBTPT + | metominostrobin |
| | NPTPT | |
| M-41 | NBTPT + | picoxystrobin |
| | NPTPT | |
| M-42 | NBTPT + | trifloxystrobin |
| | NPTPT | |
| M-43 | NBTPT + | pyrametostrobin |
| | NPTPT | |
| M-44 | NBTPT + | pyraoxystrobin |
| | NPTPT | |
| M-45 | NBTPT + | coumoxystrobin |
| | NPTPT | |
| M-46 | NBTPT + | coumethoxystrobin |
| | NPTPT | |
| M-47 | NBTPT + | fenaminostrobin |
| | NPTPT | |
| M-48 | NBTPT + | flufenoxystrobin |
| | NPTPT | |

Within the mixtures of table 1, the following mixtures are preferred: M-1, M-3, M-4, M-6, M-7, M-9, M-10, M-13, M-17, M-19, M-20, M-22, M-23, M-25, M-26, M-29, M-33, M-35, M-36, M-38, M-39, M-41, M-42 and M-45. Within this subset, the following mixtures are especially preferred: M-1, M-3, M-4, M-9, M-10, M-17, M-19, M-20, M-25, M-26, M-29, M-33, M-35, M-36, M-41, M-42 and M-45.The following mixtures are most preferred: M-1, M-3, M-4, M-17, M-19, M-20, M-33, M-34 and M-35. Utmost preference is given to mixture M-33.

All mixtures set forth above are also an embodiment of the present invention.

In one embodiment of the invention, NBTPT and/or NPTPT (component A) is applied with one strobilurin (component B).

In one embodiment of the invention, NBTPT and/or NPTPT (component A) is applied with two strobilurins (component B).

In one embodiment of the invention, NBTPT and/or NPTPT (component A) is applied with three or even more strobilurins (component B).

In one embodiment of the invention, the method according to the invention comprises the application of the agrochemical mixture to a plant and/or the soil where the plant is growing or is intended to grow and/or the seeds from which the plant grows.

In one embodiment of the invention, the soil and a plant that is growing on the soil is treated with an effective amount of the agrochemical mixture.

In one embodiment of the invention, the plant is plant propagation material from which the plant grows.

In one embodiment, the aforementioned method for reducing nitrous oxide and/or ammonia emission from soils comprises treating the plant propagules, preferably the seeds of an agricultural, horticultural, ornamental or silivicultural plant.

In one embodiment, the seed is transgenic.

In a preferred embodiment of the invention, seed is treated with at least one strobilurin (component B).

In a preferred embodiment of the invention, seed is treated with pyraclostrobin (component B).

In one embodiment of the invention, the application of the composition (component A) comprising N-n-butylthiophosphoric triamide (NBTPT) and/or N-n-propylthiophosphoric triamide (NPTPT) is carried out as foliar application.

In a preferred embodiment of the invention, the composition (component A) comprising N-n-butylthiophosphoric triamide (NBTPT) and/or N-n-propylthiophosphoric triamide (NPTPT) is applied to the soil in-furrow and/or as side-dress and/or as broadcast.

In one embodiment of the invention, the soil is treated with an effective amount of the mixture.

In one embodiment of the invention, a plant growing on soil is treated with an effective amount of the mixture.

In one embodiment of the invention, the at least one fertilizer comprising urea (component C) is applied as foliar application.

In a preferred embodiment of the invention, the at least one fertilizer comprising urea (component C) is applied to the soil in-furrow and/or as side-dress and/or as broadcast.

In the terms of the present invention “mixture” or “agrochemical mixture” means a combination of at least two active compounds. The terms “mixture” and “agrochemical mixture” are interchangeable.

The term “at least one” is to be understood as 1, 2, 3 or more. A mixture comprising at least one strobilurin refers for example to a mixture comprising 1, 2, 3 or more strobilurins.

The term “plants” is to be understood as plants of economic importance and/or men-grown plants. They are preferably selected from agricultural, silvicultural, ornamental and horticultural plants, each in its natural or genetically modified form. The term “plant” as used herein includes all parts of a plant such as germinating seeds, emerging seedlings, herbaceous vegetation as well as established woody plants including all belowground portions (such as the roots) and aboveground portions.

The term “soil” is to be understood as a natural body comprised of living (e.g. microorganisms (such as bacteria and fungi), animals and plants) and non-living matter (e.g. minerals and organic matter (e.g. organic compounds in varying degrees of decomposition), liquid, and gases) that occurs on the land surface, and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

The term “nitrification inhibitors” is to be understood as any chemical substance which slows down or stops the nitrification process. Nitrification inhibitors retard the natural transformation of ammonium into nitrate, by inhibiting the activity of bacteria such as Nitrosomonas spp. and/or Archaea.

The term “nitrification” is to be understood as the biological oxidation of ammonia (NH₃) or ammonium (NH₄⁺) with oxygen into nitrite (NO₂⁻) followed by the oxidation of these nitrites into nitrates (NO₃⁻) by microorganisms. Besides nitrate (NO₃⁻) nitrous oxide is also produced though nitrification. Nitrification is an important step in the nitrogen cycle in soil.

The term “denitrification” is to be understood as the microbiological conversion of nitrate (NO₃⁻) and nitrite (NO₂⁻) to gaseous forms of nitrogen, generally N₂ or N₂O. This respiratory process reduces oxidized forms of nitrogen in response to the oxidation of an electron donor such as organic matter. The preferred nitrogen electron acceptors in order of most to least thermodynamically favorable include: nitrate (NO₃⁻), nitrite (NO₂⁻), nitric oxide (NO), and nitrous oxide (N₂O). Within the general nitrogen cycle, denitrification completes the cycle by returning N₂ to the atmosphere. The process is performed primarily by heterotrophic bacteria (such as Paracoccus denitrificans and various pseudomonads), although autotrophic denitrifiers have also been identified (e.g. Thiobacillus denitrificans). Denitrifiers are represented in all main phylogenetic groups. When faced with a shortage of oxygen many bacterial species, are able switch from using oxygen to using nitrates to support respiration in a process known as denitrification, during which the water-soluble nitrates are converted to gaseous products, including nitrous oxide, that are emitted into the atmosphere.

“Nitrous oxide”, commonly known as happy gas or laughing gas, is a chemical compound with the chemical formula N₂O. At room temperature, it is a colorless non-flammable gas. Nitrous oxide is produced naturally in soils through the microbial processes of nitrification and denitrification. These natural emissions of nitrous oxide can be increased by a variety of agricultural practices and activities including for example a) direct addition of nitrogen to soils by using mineral and organic fertilizers, b) growing of nitrogen-fixing crops, c) cultivation of high organic content soils.

The term “fertilizers” is to be understood as chemical compounds applied to promote plant and fruit growth. Fertilizers are typically applied either through the soil (for uptake by plant roots) or by foliar feeding (for uptake through leaves). The term “fertilizers” can be subdivided into two major categories: a) organic fertilizers (composed of decayed plant/animal matter) and b) inorganic fertilizers (composed of chemicals and minerals). Organic fertilizers include slurry, worm castings, peat, seaweed, sewage, and guano. Manufactured organic fertilizers include compost, blood meal, bone meal and seaweed extracts. Further examples are enzymatically digested proteins, fish meal, and feather meal. The decomposing crop residue from prior years is another source of fertility. In addition, naturally occurring minerals such as mine rock phosphate, sulfate of potash and limestone are also considered inorganic fertilizers. Inorganic fertilizers are usually manufactured through chemical processes (such as the Haber-Bosch process), also using naturally occurring deposits, while chemically altering them (e.g. concentrated triple superphosphate). Naturally occurring inorganic fertilizers include Chilean sodium nitrate, mine rock phosphate, and limestone.

The term “fertilizer comprising urea” (urea fertilizer) is defined as synthetic fertilizers comprising urea, excluding any naturally occuring fertilizers comprising urea (for instance manure as an example for a naturally occuring fertilizer comprising urea). Examples of fertilizer comprising urea are urea ammonium nitrate (UAN), isobutylidene diurea (IBDU), crotonylidene diurea (CDU) and urea formaldehyde (UF). Urea is usually made as granulated material or prills. Urea fertilizer can be produced by dropping the liquid urea from a prill tower while drying the product. Urea can also be obtained as a liquid formulation, which may be used for foliar application, e.g. on potatoes, wheat, vegetables and soybeans as well as liquid application to the field. It is commonly mixed with ammonium nitrate to form UAN with 28% N.

The term “locus” (plant habitat) is to be understood as any type of environment, soil, area or material where the plant is growing or intended to grow. Especially preferred according to the invention is soil.

The term “synergistically effective amount” refers to the fact that the purely additive effect (in mathematical terms) of the application of the individual compounds is surpassed by the application of the inventive mixture.

The term “effective amount” denotes an amount of the inventive mixtures, which is sufficient for achieving the synergistic effect, in particular the reduction of nitrous oxide and/or ammonia emission of soils as defined herein. More exemplary information about amounts, ways of application and suitable ratios to be used is given below. The skilled artisan is well aware of the fact that such an amount can vary in a broad range and is dependent on various factors, e.g. the current condition of the treated soil and the type of plant.

The plants to be treated according to the invention are selected from the group consisting of agricultural, silvicultural, ornamental and horticultural plants, each in its natural or genetically modified form. Preferably, non-transgenic agricultural plants are treated.

Preferred agricultural plants are field crops selected from the group consisting of potatoes, sugar beets, wheat, barley, rye, oat, sorghum, rice, maize, cotton, rapeseed, oilseed rape, canola, soybeans, peas, field beans, sunflowers, sugar cane; cucumbers, tomatoes, onions, leeks, lettuce, squashes; even more preferably the plant is selected from the group consisting of wheat, barley, oat, rye, soybean, maize, oilseed rape, cotton, sugar cane, rice and sorghum.

In a preferred embodiment of the invention, the plant to be treated is selected from the group consisting of tomato, potato, wheat, barley, oat, rye, soybean, maize, oilseed rape, canola, sunflower, cotton, sugar cane, sugar beet, rice, sorghum, pasture grass and grassland.

In another preferred embodiment of the invention, the plant to be treated is selected from the group consisting of tomato, potato, wheat, barley, oat, rye, soybean, maize, oilseed rape, canola, sunflower, cotton, sugar cane, sugar beet, rice and sorghum.

In an especially preferred embodiment of the invention, the plants to be treated are selected from the group consisting of tomato, wheat, barley, oat, rye, maize, oilseed rape, canola, sugar cane, and rice.

In one embodiment, the plant to be treated according to the method of the invention is an agricultural plant. “Agricultural plants” are plants of which a part (e.g. seeds) or all is harvested or cultivated on a commercial scale or which serve as an important source of feed, food, fibres (e.g. cotton, linen), combustibles (e.g. wood, bioethanol, biodiesel, biomass) or other chemical compounds. Preferred agricultural plants are for example cereals, e.g. wheat, rye, barley, triticale, oats, sorghum or rice, beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rapeseed, oilseed rape, canola, linseed, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins;

vegetables, such as spinach, lettuce, asparagus, cabbages, carrots, onions, tomatoes, potatoes, cucurbits or paprika; lauraceous plants, such as avocados, cinnamon or camphor; energy and raw material plants, such as maize, soybean, rapeseed, canola, sugar cane or oil palm; tobacco; nuts; coffee; tea; bananas; vines (table grapes and grape juice grape vines); hop; turf; natural rubber plants.

Pasture grass and grassland are composed of grass or grass mixtures comprising for example Bluegrass (Poa spp.), Bentgrass (Agrostis spp.), Ryegrasses (Lolium spp.), Fescues (Festuca spp., hybrids, and cultivars), Zoysiagrass (Zoysia spp.), Bermudagrass (Cynodon spp.), St. Augustine grass, Bahiagrass (Paspalum), Centipedegrass (Eremachloa),

Carpetgrass (Axonopus), Buffalograss and Grama grass. Pastures may be also composed of mixtures comprising afore mentioned grasses, for example Ryegrass, and Trifolium species, for example Trifolium pratensis and Trifolium repens, Medicago species like Medicago sativa, Lotus species like Lotus corniculatus, and Melilotus species, for example Melilotus albus.

In one embodiment, the plant to be treated according to the method of the invention is a horticultural plant. The term “horticultural plants” are to be understood as plants which are commonly used in horticulture—e.g. the cultivation of ornamentals, vegetables and/or fruits. Examples for ornamentals are turf, geranium, pelargonia, petunia, begonia and fuchsia. Examples for vegetables are potatoes, tomatoes, peppers, cucurbits, cucumbers, melons, watermelons, garlic, onions, carrots, cabbage, beans, peas and lettuce and more preferably from tomatoes, onions, peas and lettuce. Examples for fruits are apples, pears, cherries, strawberry, citrus, peaches, apricots and blueberries.

In one embodiment, the plant to be treated according to the method of the invention is an ornamental plants. “Ornamental plants” are plants which are commonly used in gardening, e.g. in parks, gardens and on balconies. Examples are turf, geranium, pelargonia, petunia, begonia and fuchsia.

In one embodiment, the plant to be treated according to the method of the invention is a silvicultural plant. The term “silvicultural plant” is to be understood as trees, more specifically trees used in reforestation or industrial plantations. Industrial plantations generally serve for the commercial production of forest products, such as wood, pulp, paper, rubber tree, Christmas trees, or young trees for gardening purposes. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm, and oak.

The term “genetically modified plants” is to be understood as plants, which genetic material has been modified by the use of recombinant DNA techniques in a way that under natural circumstances it cannot readily be obtained by cross breeding, mutations or natural recombination.

The term “plant propagation material” is to be understood to denote all the generative parts of the plant such as seeds and vegetative plant material such as cuttings and tubers (e.g. potatoes), which can be used for the multiplication of the plant. This includes seeds, grains, roots, fruits, tubers, bulbs, rhizomes, cuttings, spores, offshoots, shoots, sprouts and other parts of plants, including seedlings and young plants, which are to be transplanted after germination or after emergence from soil, meristem tissues, single and multiple plant cells and any other plant tissue from which a complete plant can be obtained.

The term “propagules” or “plant propagules” is to be understood to denote any structure with the capacity to give rise to a new plant, e.g. a seed, a spore, or a part of the vegetative body capable of independent growth if detached from the parent. In a preferred embodiment, the term “propagules” or “plant propagules” denotes for seed.

The reduction of nitrous oxide and/or ammonia emission is independent of the presence of phytopathogenic pests. Accordingly, in a preferred embodiment of the method, the application of the agricultural mixture according to the invention is carried out in the absence of pest pressure which may have an impact on the health of a plant.

The term “BBCH principal growth stage” refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from the Federal Biological Research Centre for Agriculture and Forestry (Germany), the Bundessortenamt (Germany) and the chemical industry.

In one embodiment of the invention, the agrochemical mixture is applied at a growth stage (GS) between GS 00 and GS 65 BBCH of the plant.

In preferred embodiment of the invention, the agrochemical mixture is applied at a growth stage between GS 00 and GS 55 BBCH of the plant.

In a more preferred embodiment of the invention, the agrochemical mixture is applied at the growth stage between GS 00 and GS 47 BBCH of the plant.

In one embodiment of the invention, at least one fertilizer comprising urea (component C) is applied before and at sowing, before emergence, and until harvest (GS 00 to GS 89 BBCH).

In another embodiment of the invention, at least one fertilizer comprising urea (component C) is applied together with at least one nitrification inhibitor (component D) before and at sowing, before emergence, and until harvest (GS 00 to GS 89 BBCH).

In a preferred embodiment of the invention, the application according to the method of the current invention is repeatedly carried out. In one embodiment, the application is repeated two to ten times, preferably, two to five times; most preferably two times.

For the use according to the invention, the application rate of component (A) is between 0.1 g and 2 kg of active ingredient per hectare, preferably between 1 g and 0.75 kg of active ingredient per hectare, especially preferred between 2 g and 0.3 kg of active ingredient per hectare.

For the use according to the invention, the application rate of component (B) is between 0.001 g and 500 g of active ingredient per hectare, preferably between 0.001 g and 250 g of active ingredient per hectare, especially preferred between 0.001 g and 110 g of active ingredient per hectare depending on different parameters such as the specific active ingredient applied and the plant species treated.

If seed is treated with a strobilurin (component B), amounts of from 0.001 g to 20 g per kg of seed, preferably from 0.01 g to 10 g per kg of seed, and more preferably from 0.05 to 5 g per kg are generally required.

For the use according to the invention, the application rates of component (C) are between 5 kg and 350 kg of N per hectare, preferably between 10 kg and 300 kg of N per hectare, and especially preferably between 40 kg and 250 kg of N per hectare.

For the use according to the invention, the application rates of component (D) are between 1 g and 100 kg per hectare, preferably between 2 g and 85 kg per hectare, even more preferably 500 g and 30 kg per hectare.

The agrochemical mixture comprising NBTPT and/or NPTPT as component (A) and at least one strobilurin as component (B) are used in synergistically effective amounts.

Components (C) and (D) are used in an effective and non-phytotoxic amount. This means that they are used in a quantity which allows to obtain the desired effect but which does not give rise to any phytotoxic symptoms on the treated plant or on the plant raised from the treated propagule or treated soil.

With respect to the mixtures according to the invention, the weight ratio of component (A) to component (B) in the case of seed, treated with component (B) is preferably between 1000:1, and 10:1, more preferably between 600:1 and 20:1, and in particular between 200:1 and 30:1. The utmost preferred ratio is between 100:1 and 40:1. For example, specific mixtures could contain a relation of component (A) to component (B) of 500:1, more preferably of 200:1, even more preferably of 100:1 and most preferably of 60:1.

With respect to the mixtures according to the invention, the weight ration of component (A) to component (B) in the case of liquid application of component (B) is preferably between 20:1 and 0.5:1, more preferably between 10:1 and 0.8:1, and in particular between 8:1 and 1:1. The utmost preferred ratio is between 4:1 and 1.1:1. For example, specific mixtures could contain a relation of component (A) to component (B) of 8:1, more preferred of 5:1, even more preferred of 4:1 and most preferred of 1.2:1.

The active compounds according to the invention can be present in different crystal modifications whose biological activity may differ. They are likewise subject matter of the present invention.

The compounds according to the invention, their N-oxides and salts can be converted into customary types of agrochemical compositions, e.g. solutions, emulsions, suspensions, dusts, powders, pastes, prills and granules. The composition type depends on the particular intended purpose; in each case, it should ensure a fine and uniform distribution of the compounds or the agrochemical mixture according to the invention.

Compositions such as prills and granules may be coated. Coatings consist of materials that act as a physical barrier which may result in a slow and controlled release of the coated material. Fertilizers may for example be coated with inorganic materials such as sulfur or mineral-based coatings or with an organic polymer. A compilation of the various technical coating processes is given by Goertz, H. M. (1993) Controlled Release Technology. Kirk-Othmer “Encyclopedia of Chemical Technology, Vol.7 Controlled Release Technology (Agricultural), pp. 251-274. Further details on manufacturing processes mainly used in Japan are given by Shoiji and Ganzdeza (1992), Fujita et al. (1977), and on the “Reactive Layer Coating” process by Purcell (1995). Models of coated fertilizers developed in Israel are described by Lupu (1996), Reiss (1996) and Shavit et al. (1994). Additional information is provided in Goertz, H. M. (1995) Technology Developments in Coated Fertilizers. Proceedings: Dahlia Greidinger Memorial International Workshop on Controlled/Slow Release Fertilizers, Technion—Israel institute, Haifa, Israel; Shoji, S. and Gandeza, A. T. (1992) Controlled release fertilizers with polyolefin resin coating. Kanno Printing C. Ltd. Sendai, Japan; Fujita, T., Takahashi, C., Ohshima, M. and Shimizu, H. (1977) Method for producing coated fertilizers U.S. Pat. No. 4,019,890; Purcell Inc. (1995) Polyon Polymer Coatings and the RLC (tm) Process. Purcell Industries, Inc. Sylacauga, Ala., USA; Lupu, R. (1996) Polyurethane based hydrophobic membranes for controlled release of fertilizers. Research thesis. Israel Institute of Technology, Haifa, Isreal; Reiss, M. (1996) Nutrient controlled release from gel-based devices. Research thesis. Israel Institute of Technology, Haifa, Israel; Shavit, U., Shaviv, A. and Zaslaysky, D. (1994) New type of hydropholic polymer based controlled release fertilizer. Proceedings International Symposium on Controlled Release and Bioactive Materials 21. Controlled Release Society.

Examples for composition types are suspensions (SC, OD, FS), emulsifiable concentrates (EC), emulsions (EW, EO, ES), microemulsions (ME), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF). Usually the composition types (e.g. SC, OD, FS, EC, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 und ff. WO 91/13546, U.S. Pat. No. 4,172,714, U.S. Pat. No. 4,144,050, U.S. Pat. No. 3,920,442, US 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical compositions may also comprise auxiliaries which are customary in agrochemical compositions. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as N-methylpyrrolidone. Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany),and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i.e. compounds that impart a modified flowability to compositions, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., N.J., USA).

Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan). Powders, materials for spreading and dusts can be prepared by mixing or concomitantly grinding the compounds I and, if appropriate, further active substances, with at least one solid carrier. Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g. ammonium sulfate, ammonium phosphate, ammonium nitrate, ureas, and products of vegetable origin, such as cereal meal, tree bark meal, wood meal and nutshell meal, cellulose powders and other solid carriers.

Examples for composition types are:

1. Composition Types for Dilution with Water

i) Water-soluble Concentrates (SL, LS) 10 parts by weight of a agrochemical mixture according to the invention are dissolved in 90 parts by weight of water or in a water-soluble solvent. As an alternative, wetting agents or other auxiliaries are added. The active substance dissolves upon dilution with water. In this way, a composition having a content of 10% by weight of active substance is obtained.
ii) Dispersible Concentrates (DC) 20 parts by weight of a agrochemical mixture according to the invention are dissolved in 70 parts by weight of cyclohexanone with addition of 10 parts by weight of a dispersant, e.g. polyvinylpyrrolidone. Dilution with water gives a dispersion. The active substance content is 20% by weight.
iii) Emulsifiable Concentrates (EC) 15 parts by weight of a agrochemical mixture according to the invention are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

### iv) Emulsions (EW, EO, ES)

25 parts by weight of a agrochemical mixture according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

### v) Suspensions (SC, OD, FS)

In an agitated ball mill, 20 parts by weight of a agrochemical mixture according to the invention are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

### vi) Water-dispersible Granules and Water-soluble Granules (WG, SG)

50 parts by weight of a agrochemical mixture according to the invention are ground finely with addition of 50 parts by weight of dispersants and wetting agents and prepared as water-dispersible or water-soluble granules by means of technical appliances (e.g. extrusion, spray tower, fluidized bed). Dilution with water gives a stable dispersion or solution of the active substance. The composition has an active substance content of 50% by weight.

vii) Water-dispersible Powders and Water-soluble Powders (WP, SP, SS, WS)

75 parts by weight of a agrochemical mixture according to the invention are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of a agrochemical mixture according to the invention are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

2. Composition Types to be Applied Undiluted

ix) Dustable pPowders (DP, DS)

5 parts by weight of a agrochemical mixture according to the invention are ground finely and mixed intimately with 95 parts by weight of finely divided kaolin. This gives a dustable composition having an active substance content of 5% by weight.

### x) Granules (GR, FG, GG, MG)

0.5 parts by weight of a agrochemical mixture according to the invention is ground finely and associated with 99.5 parts by weight of carriers. Current methods are extrusion, spray-drying or the fluidized bed. This gives granules to be applied undiluted having an active substance content of 0.5% by weight.

### xi) ULV Solutions (UL)

10 parts by weight of a agrochemical mixture according to the invention are dissolved in 90 parts by weight of an organic solvent, e.g. xylene. This gives a composition to be applied undiluted having an active substance content of 10% by weight.

The agrochemical compositions generally comprise between 0.01 and 95%, preferably between 0.1 and 90%, most preferably between 0.5 and 90%, by weight of active substance. The active substances are employed in a purity of from 90% to 100%, preferably from 95% to 100% (according to NMR spectrum).

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting, soaking and in-furrow application methods of the propagation material. In a preferred embodiment, the compounds or the compositions thereof, respectively, are applied on to the plant propagation material by a method such that germination is not induced, e.g. by seed dressing, pelleting, coating and dusting.

In a preferred embodiment, a suspension-type (FS) composition is used for seed treatment. Typically, a FS composition may comprise 1 to 800 g/l of active substance, 1 to 200 g/l surfactant, 0 to 200 g/l antifreezing agent, 0 to 400 g/l of binder, 0 to 200 g/l of a pigment and up to 1 liter of a solvent, preferably water.

The active substances can be used as such or in the form of their compositions, e.g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the active substances according to the invention. Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of active substance.

The active substances may also be used successfully in the ultra-low-volume process (ULV), it being possible to apply compositions comprising over 95% by weight of active substance, or even to apply the active substance without additives.

Various types of oils, wetters, adjuvants, herbicides, bactericides, other fungicides and/or pesticides may be added to the active substances or the compositions comprising them, if appropriate not until immediately prior to use (tank mix). These agents can be admixed with the compositions according to the invention in a weight ratio of 1:100 to 100:1, preferably 1:10 to 10:1.

Adjuvants which can be used are in particular organic modified polysiloxanes such as Break Thru S 240®; alcohol alkoxylates such as Atplus 245®, Atplus MBA 1303C), Plurafac LF 300® and Lutensol ON 30®; EO/PO block polymers, e.g. Pluronic RPE 2035® and Genapol B®; alcohol ethoxylates such as Lutensol XP 80®; and dioctyl sulfosuccinate sodium such as Leophen RA®.

1-18. (canceled)

19. An agrochemical mixture for reducing nitrous oxide and/or ammonia emission from soils, comprising:
1) a composition (component A) comprising N-n-butylthiophosphoric triamide (NBTPT) and/or N-n-propylthiophosphoric triamide (NPTPT); and
2) at least one strobilurin (component B) selected from the group consisting of pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N methyl-acetamide
in synergistically effective amounts.

20. The mixture according to claim 19, wherein the strobilurin (component B) is selected from the group consisting of pyraclostrobin, orysastrobin, azoxystrobin, dimoxystrobin, enestroburin, fluoxastrobin, kresoxim-methyl, metominostrobin, picoxystrobin and trifloxystrobin.

21. The mixture according to claims 19, wherein the strobilurin (component B) is pyraclostrobin.

22. The mixture according to claim 19, additionally comprising at least one fertilizer comprising urea (component C).

23. The mixture according to claim 22, wherein the fertilizer (component C) comprises urea in a form selected from the group consisting of urea, urea ammonium nitrate (UAN), isobutylidene diurea (IBDU), crotonylidene diurea (CDU) and urea formaldehyde (UF).

24. The mixture according to claim 19, additionally comprising at least one nitrification inhibitor (component D) selected from the group consisting of 2-(3,4-dimethyl-pyrazol-1-yl)-succinic acid, 3,4-dimethylpyrazole (DMP), 3,4-dimethylpyrazolephosphate (DMPP), dicyandiamide (DCD), 1H-1,2,4-triazole, 3-methylpyrazole (3-MP), 2-chloro-6-(trichloromethyl)-pyridine, 5-ethoxy-3-trichloromethyl-1,2,4-thiadiazol, 2-amino-4-chloro-6-methyl-pyrimidine, 2-mercapto-benzothiazole, 2-sulfanilamidothiazole, thiourea, sodium azide, potassium azide, 1-hydroxypyrazole, 2-methylpyrazole-1-carboxamide, 4-amino-1,2,4-triazole, 3-mercapto-1,2,4-triazole, 2,4-diamino-6-trichloromethyl-5-triazine, carbon bisulfide, ammonium thiosulfate, sodium trithiocarbonate, 2,3-dihydro-2,2-dimethyl-7-benzofuranol methyl carbamate and N-(2,6-dimethylphenyl)-N-(methoxyacetyl)-alanine methyl ester.

25. A method for reducing nitrous oxide and/or ammonia emission from soils comprising treating plant propagules or agricultural, horticultural, ornamental or silivicultural seeds or the soil where plants grow or the seeds will be planted with a synergistically effective amount of a mixture as defined in claim 19.

26. The method according to claim 25, whereas the composition (component A) comprising N-n-butylthiophosphoric triamide (NBTPT) and/or N-n-propylthiophosphoric triamide (NPTPT) is applied to the soil in-furrow and/or as side-dress and/or as broadcast.

27. The method according to claim 25, wherein a plant growing on soil is treated with the mixture

28. The method according to claim 25, whereas seed is treated with at least one strobilurin (component B).

29. The method according to claim 25 whereas the at least one fertilizer comprising urea (component C) is applied to the soil in-furrow and/or as side-dress and/or as broadcast.

30. The use according to claim 25, whereas components (A), (B), (C) and (D) are formulated separately but applied simultaneously or subsequently, whereas the subsequent application is carried out within a time interval which allows a combined action of the individual components.

31. The method according to claim 25, whereas components (A) and (C) are co-formulated and applied simultaneously.

32. The method according to claim 25, whereas the agrochemical mixture comprises a composition comprising N-n-butylthiophosphoric triamide (NBTPT) and N-n-propylthiophosphoric triamide (NPTPT) as component (A) and pyraclostrobin as component (B) in synergistically effective amounts.

33. The method according to claim 28, wherein the plant is selected from the group consisting of agricultural, silvicultural, ornamental and horticultural plants, each in its natural or genetically modified form.

34. The method according to claim 28, wherein the plant is selected from the group consisting of tomato, potato, wheat, barley, oat, rye, soybean, maize, oilseed rape, canola, sunflower, cotton, sugar cane, sugar beet, rice, sorghum, pasture grass and grassland.

35. The method according to claim 25, wherein the strobilurin (component B) is selected from the group consisting of pyraclostrobin, orysastrobin, azoxystrobin, dimoxystrobin, enestroburin, fluoxastrobin, kresoxim-methyl, metominostrobin, picoxystrobin and trifloxystrobin.

36. The method according to claim 25, wherein the strobilurin (component B) is pyraclostrobin.

37. The method according to claim 25, additionally comprising at least one fertilizer comprising urea (component C).

38. The method according to claim 37, wherein the fertilizer (component C) comprises urea in a form selected from the group consisting of urea, urea ammonium nitrate (UAN), isobutylidene diurea (IBDU), crotonylidene diurea (CDU) and urea formaldehyde (UF).
